(19) United States
(12) Patent Application Publication
(10) Pub. No.: US 2008/0316348 A1
(43) Pub. Date: Dec. 25, 2008

(54) VIRTUAL WHITEBOARD

(75) Inventor: Zachariah Hallock, Hillsborough, NC (US)

Correspondence Address: BEYER WEAVER LLP, P.O. BOX 70250, OAKLAND, CA, 94612-0250, US

(73) Assignee: CISCO TECHNOLOGY, INC., San Jose, CA (US)

(21) Appl. No.: 11/766,578

(22) Filed: Jun. 21, 2007

(51) Int. Cl. H04N 7/15; G03B 21/14; G03B 21/32

(52) U.S. Cl. 348/333.1; 353/121; 353/20

(57) ABSTRACT

In one embodiment, an apparatus comprises a first camera configured to receive a first image via a first polarized filter, a second camera configured to receive a second image via a second polarized filter, a first projector coupled to the second camera via a communication link, the first projector configured to project the second image onto a first presentation screen via a third polarized filter, the third polarized filter being substantially opposite in polarization from the second polarized filter, and a second projector coupled to the first camera via the communication link, the second projector configured to project the first image onto a second presentation screen via a fourth polarized filter, the fourth polarized filter being substantially opposite in polarization from the first polarized filter.

### BACKGROUND

1. Technical Field

The present disclosure relates generally to real-time virtual collaboration of shared images.

2. Description of the Related Art

Real-time collaboration systems are useful for sharing information among multiple collaborators or participants, without requiring them to be physically collocated. Interpersonal communication involves a large number of subtle and complex visual cues, referred to by names like “eye contact” and “body language,” which provide additional information over and above the spoken words and explicit gestures. These cues are, for the most part, processed subconsciously by the participants, and often control the course of a meeting.

In addition to spoken words, demonstrative gestures and behavioral cues, collaboration often involves the sharing of visual information—e.g., printed material such as articles, drawings, photographs, charts and graphs, as well as videotapes and computer-based animations, visualizations and other displays—in such a way that the participants can collectively and interactively examine, discuss, annotate and revise the information. This combination of spoken words, gestures, visual cues and interactive data sharing significantly enhances the effectiveness of collaboration in a variety of contexts, such as “brainstorming” sessions among professionals in a particular field, consultations between one or more experts and one or more clients, sensitive business or political negotiations, and the like. In distributed collaboration settings, then, where the participants cannot be in the same place at the same time, the beneficial effects of face-to-face collaboration will be realized only to the extent that each of the remotely located participants can be “recreated” at each site.

### BRIEF DESCRIPTION OF THE DRAWINGS

FIGS. 1A, 1B, 1C, and 1D illustrate example layouts for the video conference.

FIGS. 2A, 2B, and 2C illustrate a method for video conferencing.

### DESCRIPTION OF EXAMPLE EMBODIMENTS

### Overview

In one embodiment, an apparatus comprises a first camera configured to receive a first image via a first polarized filter, a second camera configured to receive a second image via a second polarized filter, a first projector coupled to the second camera via a communication link, the first projector configured to project the second image onto a first presentation screen via a third polarized filter, the third polarized filter being substantially opposite in polarization from the second polarized filter, and a second projector coupled to the first camera via the communication link, the second projector configured to project the first image onto a second presentation screen via a fourth polarized filter, the fourth polarized filter being substantially opposite in polarization from the first polarized filter.

In another embodiment, a method comprises capturing a first image by a first camera via a first polarized filter, the first image pertaining to a first presentation screen at a first location, capturing a second image by a second camera via a second polarized filter, the second image pertaining to a second presentation screen at a second location, displaying the second image onto the first presentation screen by a first projector via a third filter, and displaying the first image onto the second presentation screen by a second projector via a fourth filter, wherein the first polarized filter and the second polarized filter each have a substantially opposite polarization than the third polarized filter and the fourth polarized filter.

### Example Embodiments

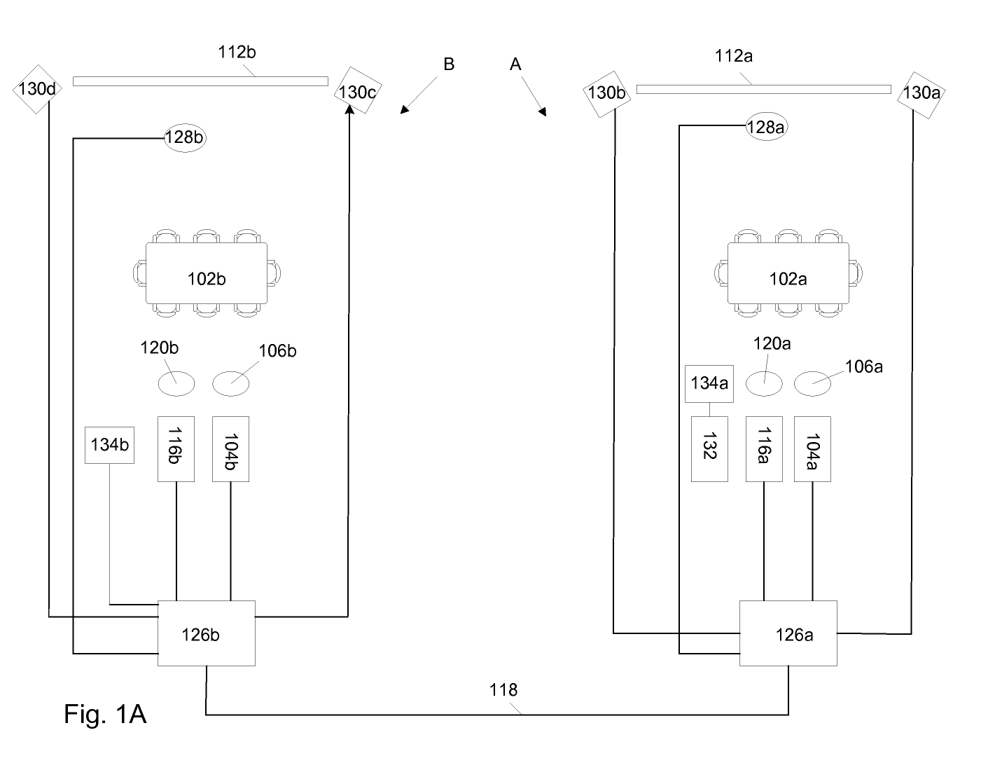

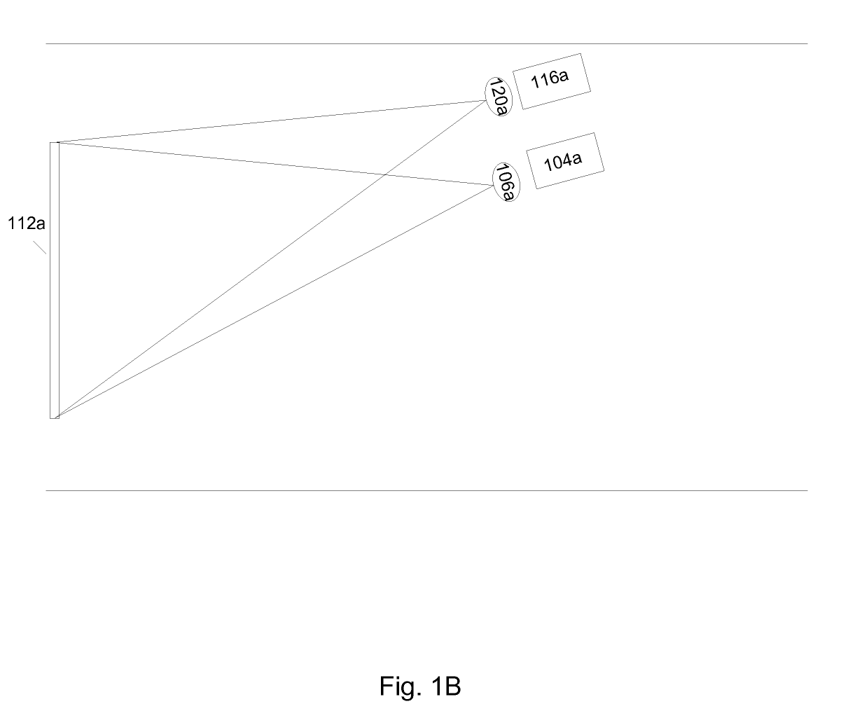

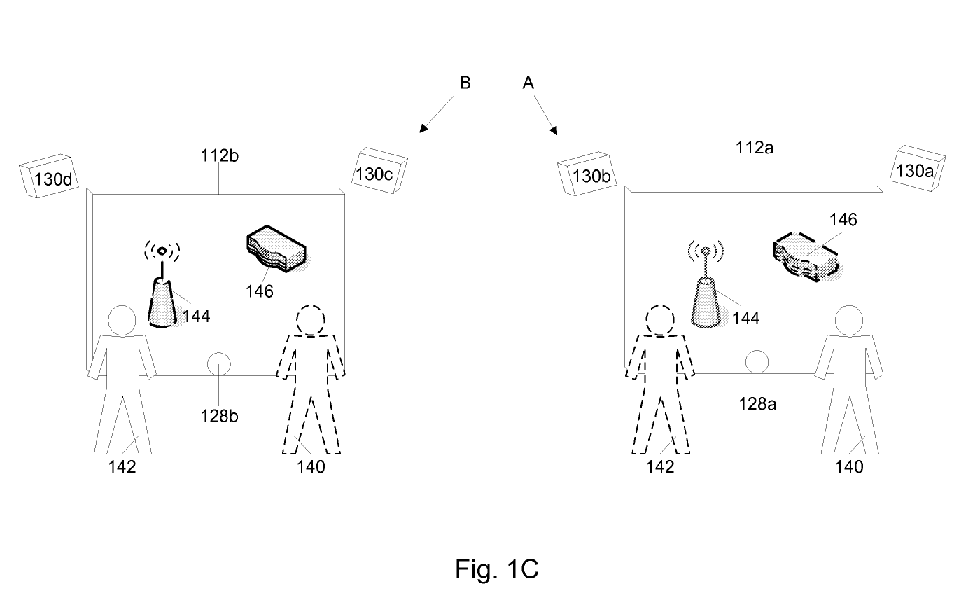

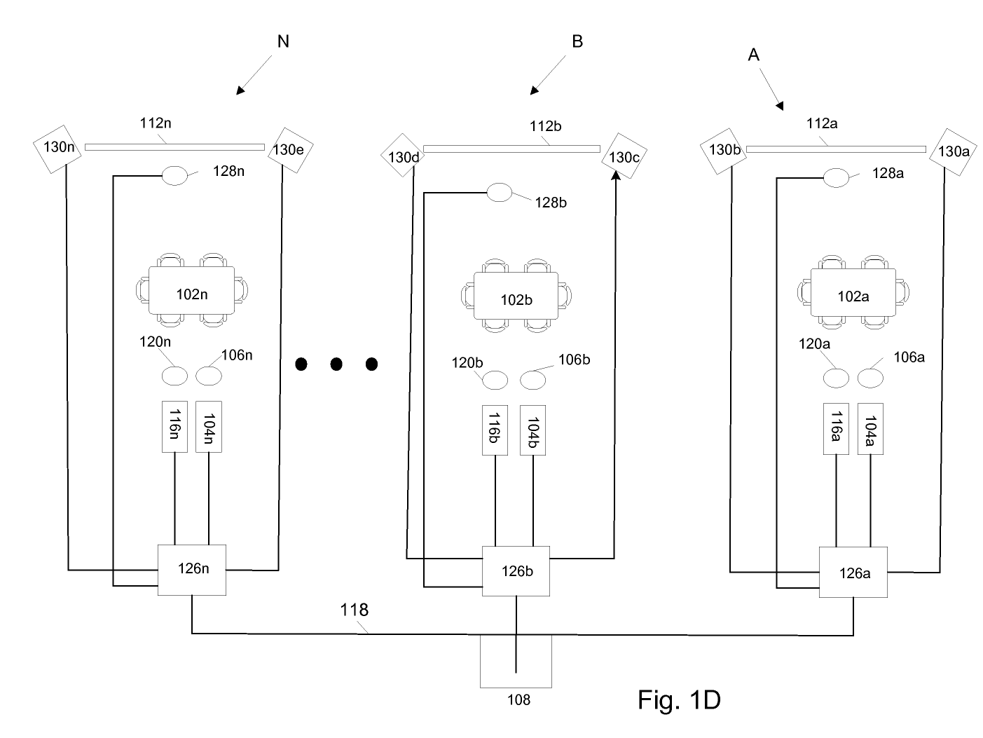

The present disclosure relates generally to real-time video conference and collaboration of shared images on a presentation screen, such as a whiteboard. The collaboration is seamless, interactive, and occurs concurrently in real-time. FIGS. 1A, 1B, 1C, and 1D illustrate example layouts for the video conference. Referring to FIG. 1A, conference room A may be located at a different location than conference room B. The locations may be in different cities, different states, different floors of the same building, and the like. Conference room A may have a first camera 104a configured to receive or capture a first image via a polarized lens or filter 106a and conference room B may have a second camera 104b configured to receive or capture a second image via a polarized lens or filter 106b. In one embodiment, polarized filters 106a, 106b have substantially the same polarization. In another embodiment, polarized filters 106a, 106b have substantially opposite polarization.

The first image may pertain to an image from the first presentation screen 112a and the second image may pertain to an image from the second presentation screen 112b. The presentation screen 112a, 112b may be a whiteboard, wall, projection screen, or any other multi-media board that provides users the ability to collaborate interactively in real-time. As described below, use of a whiteboard allows users to collaborate seamlessly and in real-time on the same figures, documents, and the like. The whiteboard may be any multi-media board such as those made by Best-Rite Manufacturing of Temple, Tex.

Conference room A may have a first projector 116a in communication with the second camera 104b at conference room B via a communication link 118. The first projector 116a may project the second image onto the first presentation screen 112a via a polarized lens or filter 120a. Conference room B may have a second projector 116b in communication with the first camera 104a at conference room A via communication link 118. The second projector 116b may project the first image onto the second presentation screen 112b via a polarized lens or filter 120b. In one embodiment, polarized filters 120a, 120b may have substantially the same polarization. In another embodiment, polarized filters 120a, 120b have substantially opposite polarization.

Polarized filters 120a, 120b for projectors 116a, 116b, respectively, may have a polarization that is nearly opposite from the polarization of polarized filters 106a, 106b for cameras 104a, 104b, respectively. For example, if polarized filters 120a, 120b were directed at approximately a 45° angle, polarized filters 106a, 106b may be directed at approximately a 125°-145° angle. In another example, if polarized filters 120a, 120b were directed at approximately a 35°-55° angle, polarized filters 106a, 106b may be directed at approximately a 130°-155° angle.

Projectors 116a, 116b project polarized light that may be received by cameras 104a, 104b. However, oppositely polarized filters 106a, 106b filter out the polarized light thereby preventing feedback loops from occurring, i.e. the remote images projected onto the local presentation screen are not reflected or transmitted back to the originating location. Thus, the image that the cameras transmit to the projectors does not include the remote images projected onto the local presentation screen, just the local images. Although a small amount of the polarized light reflected off the presentation screens 112a, 112b becomes de-polarized and is therefore not filtered out by oppositely polarized filters 106a, 106b, the amount is not substantial enough to cause a feedback loop.

Projectors 116a, 116b project polarized light resulting from the light within the projector. The polarized light may be reflected off the presentation screen causing a glare. Without the use of filters, the cameras 104a, 104b are able to receive the polarized light reflected and would transmit an image having a glare which may make the image difficult to see. However, the oppositely polarized filters 106a, 106b filter out the polarized light. Thus, the transmitted image would not have the glare when projected onto the remote projection screen. For example, projector 116a projects the second image from conference room B onto presentation screen 112a using polarized light from the projector 116a. The polarized light reflects off presentation screen 112a and is received by camera 104a. However, the polarized light is filtered out via polarized lens 106a, which is opposite in polarization from the polarized light. The polarized light is therefore neither received by camera 104a nor transmitted to projector 116b.

First projector 116a may be in communication with the second camera 104b via communication link 118 and logic devices 126a, 126b. Second projector 116b may be in communication with the first camera 104a via communication link 118 and logic devices 126a, 126b. Communication link 118 may be any network bus, wireless link, internet, and the like. Logic device may be any stand-alone device or networked device, such as a server, host device, and the like. The logic device may include a processor, encode/decode device, or other similar logic device.

Logic devices 126a, 126b may be configured to encode and decode the images. In one such example, first camera 104a receives the first image which is transmitted to and encoded by logic device 126a. The first image is then transmitted along communication link 118 to logic device 126b. Logic device 126b decodes the first image and transmits the first image to second projector 116b. Second camera 104b receives the second image from presentation screen 112b and transmits the second image to logic device 126b. Logic device 126b encodes and transmits the second image along the communication link 118 to logic device 126a. Logic device 126a decodes and transmits the second image to first projector 116a for transmission on presentation screen 112a.

FIG. 1B illustrates a side view of an example video conference layout. The first camera 104a may be positioned substantially near the first projector 116a. Although illustrated with the first camera 104a positioned below the first projector 116a, the first camera 104a may also be positioned above or co-located with the first projector 116a. The camera and projector may be calibrated to view and receive substantially the same images, i.e., the images may be of substantially the same dimension, or the images may be off-centered. This ensures that the image at conference room B matches the image at conference room A. For example, if the first camera 104a and the first projector 116a were not calibrated, the image at conference room A would not substantially match the image at conference room B. Thus, if a presenter at conference room A were to draw a figure, the viewers 102b at conference room B may not see the entire figure or perhaps a presenter at conference room B might not be able to add to or change the figure, thereby diminishing the seamless, interactive collaboration experience.

Moreover, the cameras and projectors may have substantially the same aspect ratio. This also ensures that the images seen at the presentation screens are substantially the same. For example, if the camera is a wide-screen camera, the projector should also be a wide-screen projector to allow the entire image to be viewed.

An additional light source (not shown) may be used with each presentation screen 112a, 112b to illuminate the images on the presentation screen 112a, 112b. The light source may be any light source that provides additional light to allow viewers 102a, 102b the ability to view the images on the presentation screen better. In one embodiment, the light source emits a polarized light opposite from the polarization of filters 106a, 106b. Thus, any resulting glare would not be received by the cameras as discussed above.

A microphone 128a, 128b and speakers 130a, 130b, 130c, 130d may also be used at each location to provide for audio conferencing. Microphone 128a, 128b and speakers 130a, 130b, 130c, 130d may be in communication with logic devices 126a, 126b. In use, microphone 128a may receive a first audio signal that may be transmitted to logic device 126a. In one example, logic device 126a encodes the first audio signal and transmits the first audio signal to logic device 126b along communication link 118. Logic device 126b decodes the first audio signal for transmission at speakers 130c,d. Simultaneously, microphone 128b may receive a second audio signal that may be transmitted to logic device 126b. Logic device 126b may encode the second audio signal and transmit the second audio signal to logic device 126a along communication link 118. Logic device 126a decodes the second audio signal for transmission at speakers 130a,b. Although illustrated with one microphone and two speakers at each location, the number is not intended to be limiting as any number of microphones and speakers may be used.

A computer image may also be received and viewed at each location. Referring back to FIG. 1A, in one embodiment, a computer 134a may be in communication with a third projector 132. The third projector may be used to project a computer image onto presentation screen 112a. Thus, viewers 102b at conference room B are able to view the computer image such as a Power Point™ presentation, Excel™ spreadsheet, videos, and the like. This provides for the ability to collaborate using multiple forms of media. Although illustrated with the computer 134a and third projector 132 at conference room A, the location is not intended to be limiting as the computer and third projector 132 may be located at either or both locations.

In another embodiment (see, FIG. 1C), the computer 134b may be in communication with second logic device 126b. The computer 134b may transmit the computerized image directly to second logic device 126b which may be configured to overlay the computerized image over the second image and transmit the image to second projector 116b. The computerized image may be overlaid over the second image since the second image is a live video image. Although the computer 134b is illustrated coupled to the logic device 126b in conference room B, the location is not intended to be limiting as another computer may also be coupled to logic device 126a in conference room A.

In use, presenter A 140 presents in conference room A, and presenter B 142 presents in conference room B. Each presenter may be proximate to the presentation screen 112a, 112b, respectively. First camera 104a may receive the first image of presenter A 140 and any writings, drawings, computer image, and the like from presentation screen 112a, such as the wireless access point image 144. The first image may be transmitted to and encoded by logic device 126a, transmitted along communication link 118, and decoded by logic device 126b. The first image may then be transmitted to second projector 116b for transmission onto presentation screen 112b. Thus, remote presentation screen 112a may be projected on the local presentation screen 112b.

Simultaneously, second camera 104b may receive a second image of presenter B 142 and any writings, drawings, computer images, and the like, such as the router image 146. The second image may be transmitted and encoded by logic device 126b, transmitted along communication link 118, and decoded by logic device 126a. The second image may then be transmitted to first projector 116a for transmission onto presentation screen 112a. Thus, remote presentation screen 112b may be projected on local presentation screen 112a.

At conference room A, presenter A 140 is viewed in person, but only a virtual image of remote presenter B 142 is projected by projector 116a onto presentation screen 112a. Conversely, at conference room B, presenter B 142 is viewed in person, but a virtual image of remote presenter A 140 is projected by projector 116b onto presentation screen 112b. Both presenter A 140 and B are able to simultaneously and seamlessly interact on the presentation screen and see each other write on the presentation screens 112a, 112b. They are able to collaborate and add to common diagrams and/or designs, fill in blanks or notes, complete each other's notes, figures, or equations, and the like. Additionally, computerized images, such as projection slides, may also be displayed to allow for the co-presentation of materials.

FIG. 1D illustrates an example layout for multi-point video conferencing. Users may participate and collaborate in a multi-point conference environment with multiple remote locations. As discussed above, each conference room may have a camera 104a-n, projector 116a-n, presentation screen 112a-n, microphone 128a-n, speakers 130a-n, and logic devices 126a-n. Images from conference room A, B, and N maybe received at cameras 104a-n and relayed to logic device 126a-n, respectively (where n and N is an integer). Logic devices 126a-n may encode the images and transmit the images via communication link 118 to video bridge 108. Video bridge 108 may be any video compositing/combining device such as the Cisco IP/VC3511 made by Cisco Systems, Inc. of San Jose, Calif. The video bridge 108 may combine all the images into one combined image and transmit the combined image back to logic devices 126a-n to be decoded and transmitted to projectors 116a-n, respectively.

Thus, multiple presenters may present, participate, and collaborate simultaneously, each able to virtually see what other writes and says. The multiple presenters may collaborate in a seamless, real-time, and concurrent collaboration environment.

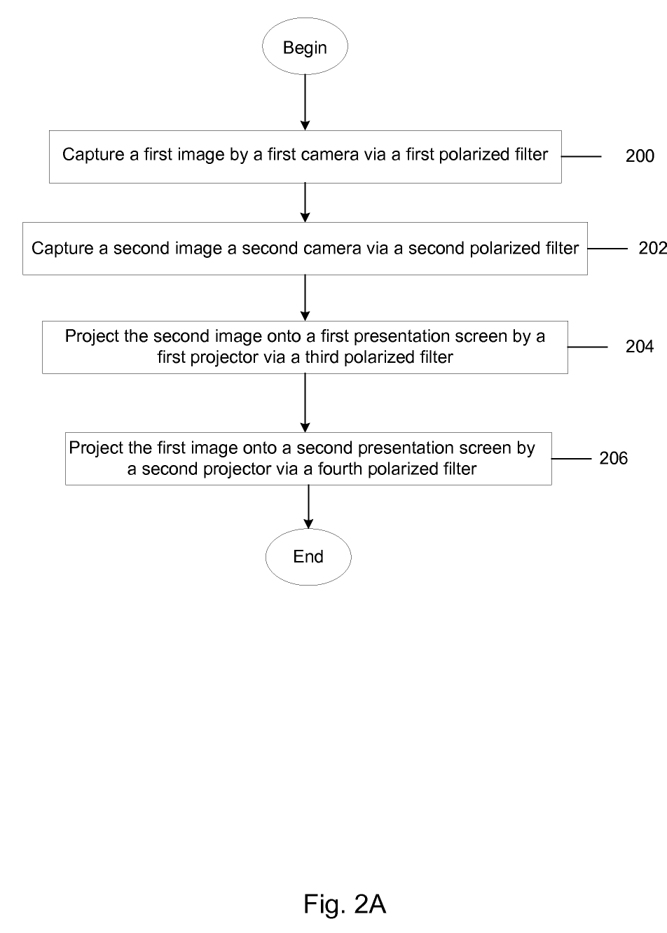

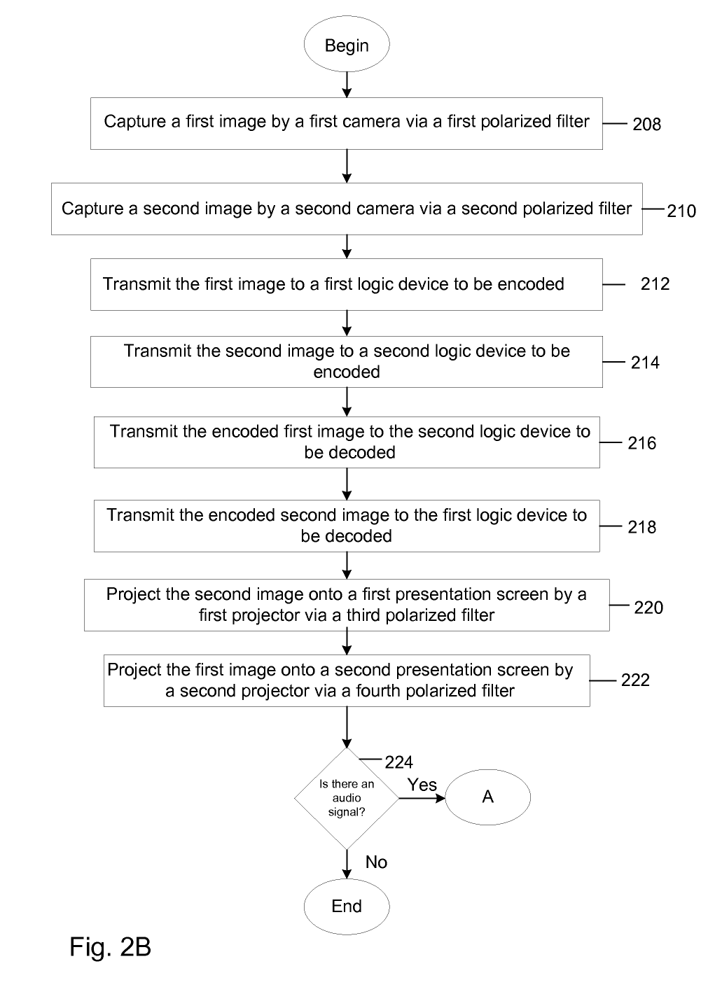

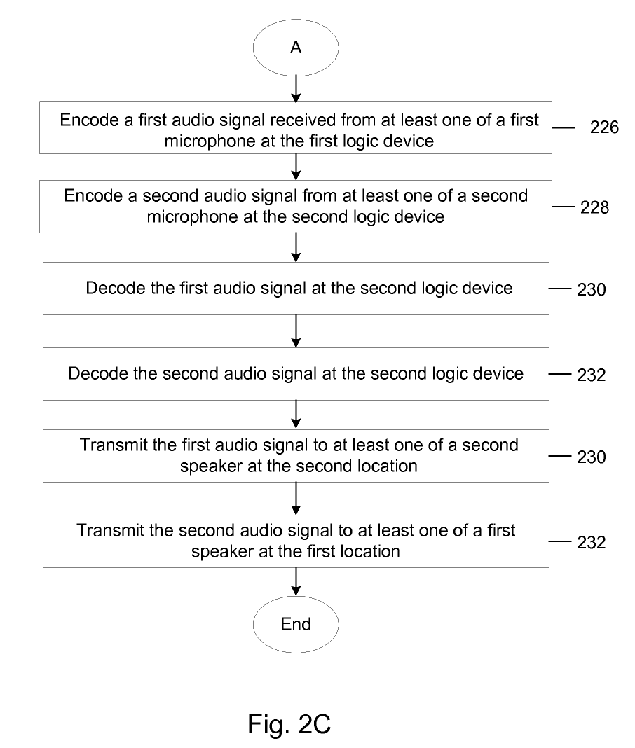

FIGS. 2A, 2B, and 2C illustrate a method for video conferencing. Referring now to FIG. 2A, a first image may be captured by a first camera via a first polarized filter at 200. The first image may be captured at a first location. A second image may be captured by a second camera via a second polarized filter at 202. The second image may be captured at a second location remote from the first location. The locations may be in different cities, different states, different floors of the same building, and the like.

The first image may pertain to an image from a first presentation screen at the first location and the second image may pertain to an image from the second presentation screen at the second location. The presentation screen may be a whiteboard, wall, projection screen, or any other multi-media board that provides users the ability to collaborate interactively in real-time.

A first projector at the first location may be in communication with the second camera at the second location via a communication link to receive the second image. The first projector may project the second image onto the first presentation screen via a third polarized lens or filter at 204. A second projector at the second location may be in communication with the first camera at the first location via a communication link to receive the first image. The second projector may project the first image onto the second presentation screen via a fourth polarized lens or filter at 206.

Referring now to FIGS. 2B and 2C, another example embodiment for video conferencing will be described. A first image may be captured by a first camera via a first polarized filter at 208. The first image may be captured at a first location. A second image may be captured by a second camera via a second polarized filter at 210. The second image may be captured at a second location remote from the first location. The locations may be in different cities, different states, different floors of the same building, and the like.

The first image may pertain to an image from a first presentation screen at the first location and the second image may pertain to an image from the second presentation screen at the second location. A first projector at the first location may be in communication with the second camera at the second location via a communication link and a first and second logic device to receive the second image. A second projector at the second location may be in communication with the first camera at the first location via a communication link and the first and second logic device to receive the first image.

Logic devices may be configured to encode and decode the images. For example, the first image may be transmitted to and encoded by a first logic device at 212 and the second image may be transmitted to and encoded by a second logic device at 214. The first image may be transmitted along the communication link to the second logic device where the image is decoded at 216 and the second image may be transmitted along the communication link to the first logic device where the image is decoded at 218. The first logic device may transmit the second image to the first projector to project the second image onto the first presentation screen via a third polarized filter at 220. The second logic device may transmit the first image to the second projector to project the first image onto the second presentation screen via a fourth polarized filter at 222. Thus, a virtual or remote image of the second presentation screen may be projected on the first presentation screen. A virtual or remote image of the first presentation screen may be projected on the second presentation screen.

In one embodiment, although not necessary, the first and second polarized filters may have substantially the same polarization and the third and fourth polarized filters may have substantially the same polarization. However, the first and second polarized filters may have a substantially opposite polarization from the third and fourth polarized filters. Thus, the polarized filters for the cameras have a different polarization than the polarized filters for the projectors. For example, if polarized filters 120a, 120b were directed at approximately a 45° angle, polarized filters 106a, 106b may be directed at approximately a 125°-145° angle. In another example, polarized filter 120a may be directed at approximately a 45°-50° angle and polarized filter 106a may be directed at approximately a 125°-145° angle. Polarized filter 120b may be directed at approximately a 135°-140° angle and polarized filter 106b may be directed at approximately a 35°-55° angle.

An audio signal may be received at 224. Microphones and speakers may be in communication with the first and second logic devices. In use, a first audio signal may be received from at least one of a first microphone at the first logic device at 226. A second audio signal may be received from at least one of a second microphone at the second logic device at 228. The first audio signal may be transmitted to the second logic device via the communication link and the second audio signal may be transmitted to the first logic device via the communication link. At the first logic device, the second audio signal may be decoded at 230. At the second logic device, the first audio signal may be decoded at 232.

Once decoded, the first audio signal may be transmitted to at least one of a second speaker at the second location at 230. The second audio signal may be transmitted to at least one of a second speaker at the first location at 232.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

1. An apparatus, comprising:
a first camera configured to receive a first image via a first polarized filter;
a second camera configured to receive a second image via a second polarized filter;
a first projector coupled to the second camera via a communication link, the first projector configured to project the second image onto a first presentation screen via a third polarized filter, the third polarized filter being substantially opposite in polarization from the second polarized filter;
a second projector coupled to the first camera via the communication link, the second projector configured to project the first image onto a second presentation screen via a fourth polarized filter, the fourth polarized filter being substantially opposite in polarization from the first polarized filter.

2. The apparatus of claim 1, wherein the first polarized filter and second polarized filter have substantially the same polarization.

3. The apparatus of claim 1, wherein the third polarized filter and fourth polarized filter have substantially the same polarization.

4. The apparatus of claim 1, wherein the first camera is positioned substantially near the first projector at a first location, wherein the first image pertains to the first presentation screen.

5. The apparatus of claim 1, wherein the second camera is positioned substantially near the second projector at a second location, wherein the second image pertains to the second presentation screen.

6. The apparatus of claim 1, wherein the first camera is positioned below the first projector and the second camera is positioned below the second projector.

7. The apparatus of claim 1, further comprising a first logic device coupled to the first camera and the first projector, the first logic device configured to encode the first image and decode the second image.

8. The apparatus of claim 7, further comprising a second logic device coupled to the second camera and the second projector, the second logic device configured to encode the second image and decode the first image.

9. The apparatus of claim 1, wherein the first projector, the second projector, the first camera, and the second camera have substantially the same aspect ratio.

10. The apparatus of claim 1, further comprising a first light source coupled to the first presentation screen and a second light source coupled to the second presentation screen.

11. The apparatus of claim 1, further comprising a first logic device configured to transmit a computerized image to a third projector, the third projector configured to project the computerized image onto the first presentation screen.

12. The apparatus of claim 7, further comprising a second logic device configured to transmit a computerized image to the first logic device, the first logic device configured to overlay the computerized image over the second image.

13. The apparatus of claim 1, further comprising a video bridge configured to receive a plurality of images from each of a plurality of cameras and transmit a combined image to each of a plurality of projectors.

14. A method, comprising:
capturing a first image by a first camera via a first polarized filter, the first image pertaining to a first presentation screen at a first location;
capturing a second image by a second camera via a second polarized filter, the second image pertaining to a second presentation screen at a second location;
displaying the second image onto the first presentation screen by a first projector via a third filter; and
displaying the first image onto the second presentation screen by a second projector via a fourth filter,
wherein the first polarized filter and the second polarized filter have a polarization substantially opposite than the third polarized filter and the fourth polarized filter.

15. The method of claim 14, wherein the capturing the first image further comprises encoding the first image and the capturing the second image further comprises encoding the second image.

16. The method of claim 14, wherein the displaying the second image further comprises decoding the second image prior to displaying the second image.

17. The method of claim 14, wherein the displaying the first image further comprises decoding the first image prior to displaying the first image.

18. The method of claim 14, further comprising:
receiving a plurality of images from a plurality of cameras by a video bridge;
combining the plurality of images to form a combined video image; and
transmitting the combined video image to each of a plurality of projectors.

19. The method of claim 14, further comprising overlaying a first computer image received from the first projector over the second image.

20. The method of claim 14, further comprising overlaying a second computer image received from the second projector over the first image.
